(19) United States
(12) Patent Application Publication
(10) Pub. No.: US 2026/0187875 A1
(43) Pub. Date: Jul. 2, 2026

(54) IMAGE PROCESSING METHOD, IMAGE PROCESSING SYSTEM AND APPARATUS, DEVICE AND MEDIUM

(71) Applicant: BOE TECHNOLOGY GROUP CO., LTD., Beijing (CN)

(72) Inventor: Yanhong Wu, Beijing (CN)

(73) Assignee: BOE TECHNOLOGY GROUP CO., LTD., Beijing (CN)

(21) Appl. No.: 19/127,469

(22) PCT Filed: Sep. 26, 2023
(86) PCT No.: PCT/CN2023/121763

§ 371 Date: May 6, 2025

(30) Foreign Application Priority Data
Nov. 18, 2022 (CN) 202211447700.6

(51) Int. Cl. G06T 11/60; G06F 3/14; G06F 3/147; G06T 5/73; G06T 7/194; G06T 11/10

(52) U.S. Cl. CPC G06T 11/60; G06F 3/1454; G06F 3/147; G06T 5/73; G06T 7/194; G06T 11/10; G06T 2207/20084; G06T 2207/20192; G06T 2207/20221; G06T 2207/30201

(57) ABSTRACT

The present disclosure provides an image processing method, an image processing system and apparatus, a device and a medium. The method includes: in response to a triggered cartoonization request for a target image, instructing a cloud server to perform portrait segmentation on the target image, to obtain a portrait image and a background image; based on a current performance parameter of the terminal, instructing a subject corresponding to the current performance parameter to perform cartoonization processing on the portrait image, and to fuse the background image and a cartoon portrait image obtained after the cartoonization processing; wherein the subject includes the terminal and/or the cloud server, and outputting a cartoon image obtained by fusing to a display device, wherein the display device is used for displaying the cartoon image.

The present disclosure claims the priority of the Chinese patent application filed on Nov. 18, 2022 before the CNIPA, China National Intellectual Property administration with the application number of 202211447700.6 and the title of “IMAGE PROCESSING METHOD, IMAGE PROCESSING SYSTEM AND APPARATUS, DEVICE AND MEDIUM”, which is incorporated herein in its entirety by reference.

### TECHNICAL FIELD

The present disclosure relates to the technical field of image processing and more particularly, to an image processing method, an image processing system and apparatus, a device and a medium.

### BACKGROUND

With the development of image processing technology, some interesting applications have emerged, which are used to perform various interesting treatments on portrait images, such as cartoonization processing.

In related art, the cartoonization processing of the images generally requires corresponding application programs to be built into the terminal. These application programs generally require various algorithms and models related to interest processing to be built in, which consumes a lot of storage resources of the terminal and puts high demands on the performance of the processor of the terminal. When completing the interesting processing of an image on the terminal, it often takes a long time and sometimes there may be problems with terminal running lag, which is not conducive to the expansion of the interesting application scenarios of the images. For example, it becomes particularly difficult to display cartoon portraits on a large number of display devices with low performance.

### SUMMARY

In a first aspect, the present disclosure provides an image processing method, and the method includes:

in response to a triggered cartoonization request for a target image, instructing a cloud server to perform portrait segmentation on the target image, to obtain a portrait image and a background image;
based on a current performance parameter of the terminal, instructing a subject corresponding to the current performance parameter to perform cartoonization processing on the portrait image, and to fuse the background image and a cartoon portrait image obtained after the cartoonization processing; wherein the subject includes the terminal and/or the cloud server; and
outputting a cartoon image obtained by fusing to a display device, wherein the display device is used for displaying the cartoon image.

Optionally, outputting a cartoon image obtained by fusing to a display device includes:
determining whether the display device is in a preset distance range based on a current communication state with the display device;
if the display device is in the preset distance range, sending the cartoon image to the display device based on communication connection with the display device; and
if the display device is not in the preset distance range, instructing the cloud server to send the cartoon image to the display device through a target gateway at a location of the display device.

Optionally, the communication connection includes at least one of Bluetooth, wireless, and near-field communication, and the gateway includes a Bluetooth gateway and/or a wireless communication gateway.

Optionally, based on a current performance parameter of the terminal, instructing a subject corresponding the current performance parameter to perform cartoonization processing on the portrait image, and to fuse the background image and a cartoon portrait image obtained after the cartoonization processing includes:
when the current performance parameter indicates that the terminal belongs to terminals of first-level performance, instructing the subject to be the terminal;
when the current performance parameter indicates that the terminal belongs to terminals of third-level performance, instructing the subject to be the cloud server; and
when the current performance parameter indicates that the terminal belongs to terminals of second-level performance, instructing that the subject includes the terminal and the cloud server;
wherein the cloud server is configured to perform the cartoonization processing on the portrait image, and the terminal is configured to fuse the background image with the cartoon portrait image obtained after the cartoonization processing.

Optionally, fuse the background image and a cartoon portrait image obtained after the cartoonization processing includes:
transferring a target style in the background image based on style information of the target style in the cartoon portrait image, to obtain a cartoonization background image; wherein the target style at least includes a color style; and
fusing the cartoonization background image and the cartoon portrait image to obtain the cartoon image.

Optionally, transferring a target style in the background image based on style information of the target style in the cartoon portrait image includes:
converting the cartoon portrait image to lab color space to obtain a first image, and converting the background image to the lab color space to obtain a second image;
correcting a value of each pixel in a corresponding channel of the second image based on mean and standard deviation of each pixel in each channel of the first image; and
converting the corrected second image to RGB color space to obtain the cartoonization background image.

Optionally, before fusing the background image and the cartoon portrait image, the method further includes:
sharpening object edges in the background image to obtain an edge image, and adjusting color brightness of the background image to obtain a color-adjusted image; and
performing edge enhancement on edges of the color-adjusted image based on the edge image to obtain an initial cartoonized background image;
wherein fusing the cartoon portrait image and the background image to obtain the cartoon image includes:
fusing the cartoon portrait image and the initial cartoonized background image to obtain the cartoon image.

Optionally, perform cartoonization processing on the portrait image includes:
inputting the portrait image into a generative adversarial network model, to perform the cartoonization processing on the portrait image; and
acquiring the cartoon portrait image output by the generative adversarial network model.

Optionally, in response to a triggered cartoonization request for a target image, instructing a cloud server to perform portrait segmentation on the target image, to obtain a portrait image and a background image includes:
in response to the cartoonization request, sending the target image to the cloud server, to instruct the cloud server to perform the portrait segmentation on the target image; or
in response to the cartoonization request, sending an attribute identifier of the target image to the cloud server, to instruct the cloud server to perform the portrait segmentation on the target image with the attribute identifier in an image library.

Optionally, fuse the background image and a cartoon portrait image obtained after the cartoonization processing includes:
acquiring a mask image for the target image output by the cloud server, wherein the mask image is used to identify a foreground area and a background area in the target image;
performing noise suppression on the mask image; and
fusing the background image and the cartoon portrait image based on the mask image after the noise suppression.

In a second aspect, the present disclosure provides an image processing method, applied to a server, and the method includes:
in response to an instruction sent by a terminal based on a cartoonization request of a target image, performing portrait segmentation on the target image, to obtain a portrait image and a background image;
when it is determined that a cloud server is a subject determined based on a current performance parameter of the terminal, performing cartoonization processing on the portrait image, and/or fusing the background image and a cartoon portrait image obtained after the cartoonization processing; and
sending a cartoon image obtained by fusing to the terminal and/or a display device.

Optionally, the cloud server connects a plurality of gateways, and sending a cartoon image obtained by fusing to a display device includes:
receiving connection information uploaded by the plurality of gateways, wherein the connection information includes a device identifier of the display device connected to the gateways;
determining a target gateway connected to the display device based on the connection information; and
sending the cartoon image to the target gateway, to instruct the target gateway to send the cartoon image to the display device.

Optionally, determining a target gateway connected to the display device based on the connection information includes:
when one gateway is connected to the display device, regarding the gateway as the target gateway; and
when the plurality of gateways are connected to the display device, acquiring signal strength between the display device and each of the plurality of gateways, and determining the target gateway based on the signal strength.

In a third aspect, the present disclosure provides an image processing system, including the cloud server, a plurality of terminals and a plurality of display devices; wherein the plurality of terminals are configured to perform the image processing method according to the first aspect, the cloud server is configured to perform the image processing method according to the second aspect, and the plurality of display devices are configured to display the cartoon image.

Optionally, the plurality of display devices include at least one of an electrophoretic display type badge, a conference doorplate, and a conference table card.

In a fourth aspect, the present disclosure provides an image processing apparatus, applied to a terminal, wherein the apparatus includes:
a response module configured for, in response to a triggered cartoonization request for a target image, instructing a cloud server to perform portrait segmentation on the target image, to obtain a portrait image and a background image;
a first cartoonization module configured for, based on a current performance parameter of the terminal, instructing a subject corresponding to the current performance parameter to perform cartoonization processing on the portrait image, and to fuse the background image and a cartoon portrait image obtained after the cartoonization processing; wherein the subject includes the terminal and/or the cloud server; and
a first sending module, configured for outputting a cartoon image obtained by fusing to a display device, wherein the display device is used for displaying the cartoon image.

In a fifth aspect, the present disclosure provides an image processing apparatus, applied to a server, wherein the apparatus includes:
a segmentation module configured for, in response to an instruction sent by a terminal based on a cartoonization request of a target image, performing portrait segmentation on the target image, to obtain a portrait image and a background image;
a second cartoonization module configured for, when it is determined that a cloud server is a subject determined based on a current performance parameter of the terminal, performing cartoonization processing on the portrait image, and/or fusing the background image and a cartoon portrait image obtained after the cartoonization processing; and
a second sending module, configured for sending a cartoon image obtained by fusing to the terminal and/or a display device.

The present disclosure further provides an electronic device, including a memory, a processor, and a computer program stored on the memory and executable on the processor, wherein the computer program, when executed by the processor, implements the image processing method according to embodiments of the first aspect or the second aspect.

The present disclosure further provides a computer-readable storage medium, wherein a computer program stored thereon causes a processor to perform the image processing method according to the embodiments of the first aspect or the second aspect of the present disclosure.

In the embodiment of the present disclosure, in response to the triggered cartoonization request for the target image, the cloud server is instructed to perform the portrait segmentation on the target image, to obtain the portrait image and the background image; based on the current performance parameter of the terminal, the subject corresponding to the cartoonization strategy is instructed to perform the cartoonization processing on the portrait image, and to fuse the background image and the cartoon portrait image obtained after the cartoonization processing; wherein the subject includes the terminal and/or the cloud server; finally, the cartoon image obtained by fusing is output to the display device to display the cartoon image on the display device.

Since in the cartoonization processing of the target image, the image segmentation is performed by the cloud server, and when performing portrait cartoonization processing, it may be performed by the terminal and/or the cloud server based on the current performance parameter of the terminal, so the tasks of each stage in the portrait cartoonization process (image segmentation, portrait cartoonization, image fusion) can be allocated to the terminal and cloud server to be completed together according to the performance of the terminal. Therefore, the application program on the terminal may avoid carrying algorithms, models, etc. related to the image segmentation, and do not require a large amount of storage resources and computing resources of the processor of the terminal, thereby reducing the performance requirements for the terminal. In this way:
on one hand, it may allow the application program to perform more refined processing of portrait cartoonization or image fusion in the image processing process, that is, more refined processing models may be implanted in the application program, so that the terminal can focus on the portrait cartoonization processing and improve the interest of the cartoonization processing.

On another hand, the application program may be installed on terminals with lower performance, so that most terminals with ordinary performance, such as mobile phones, can achieve the interesting application of image cartoonization, expanding the application scenarios.

On yet another hand, by outputting the cartoon image to the display device, the cartoon image may be sent to other display devices for display, allowing cartoon portraits to be displayed on a large number of display devices with low performance. This can expand the interesting applications of portrait cartoons to a display system with a large number of display devices with low performance.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and understandable, the specific implementation methods of the present disclosure are listed below.

### BRIEF DESCRIPTION OF THE DRAWINGS

In order to more clearly illustrate the technical solutions of the embodiments of the present disclosure or the related art, the figures that are required to describe the embodiments or the related art will be briefly described below. Apparently, the figures that are described below are some embodiments of the present disclosure, and a person skilled in the art can obtain other figures according to these figures without paying creative work. It should be noted that the scale in the attached figures is only for illustration and does not represent the actual scale.

FIG. 1 is a schematic diagram of s framework of an image processing system to which the image processing method is applied according to an embodiment of the present disclosure;

FIG. 2 is a flowchart of steps of an image processing method according to an embodiment of the present disclosure;

FIG. 3 is a scene schematic diagram of an application example of an image processing method according to an embodiment of the present disclosure;

FIG. 4 is a scene schematic diagram of an application example of an image processing method according to an embodiment of the present disclosure;

FIG. 5 is a scene schematic diagram of an application example of an image processing method according to an embodiment of the present disclosure;

FIG. 6 is a scene schematic diagram of another application example of an image processing method according to an embodiment of the present disclosure;

FIG. 7 is a schematic diagram of an overall process of cartoonization processing of a target image according to an embodiment of the present disclosure;

FIG. 8 is a schematic diagram of training of a generative adversarial network according to an embodiment of the present disclosure;

FIG. 9 is a flowchart of initial cartoonization processing for a background image according to an embodiment of the present disclosure;

FIG. 10 is a schematic diagram of image processing effect of a background image according to an embodiment of the present disclosure;

FIG. 11 is a flowchart of steps of an image processing method according to an embodiment of the present disclosure;

FIG. 12 is a schematic structural diagram of an image processing apparatus on a terminal side of the present disclosure;

FIG. 13 is a schematic structural diagram of an image processing apparatus on a server side of the present disclosure; and

FIG. 14 is a schematic structural diagram of an electronic device of the present disclosure.

### DETAILED DESCRIPTION

In order to clarify the purpose, technical solution, and advantages of the embodiments of the present disclosure, a clear and complete description of the technical solution in the embodiments of the present disclosure will be provided below in conjunction with the accompanying drawings. Obviously, the described embodiments are a part of the embodiments of the present disclosure, not all embodiments. Based on the embodiments of the present disclosure, all other embodiments obtained by persons skilled in the art without creative work are within the scope of protection of the present disclosure.

In related art, some scenarios that require to display the cartoon portrait on a large number of display devices with low performance can involve the following scenarios:

Scenario 1: In the enterprise, digital badges are configured for employees to display their profile pictures, such as identification photos (ID photos). In some cases, employees are allowed to display cartoonized images of their profile pictures on the digital badges to enhance the interest and create a relaxed office atmosphere. Some large enterprises may configure hundreds or even thousands of digital badges, which have low performance and generally only have basic communication and image display functions. In this way, it is impossible to perform cartoonization processing on the images by the digital badges. To achieve the cartoonization processing of the digital badges, hardware investment will undoubtedly be increased, which will incur high costs. If the image cartoonization processing is not performed on the digital badges, the images will be processed on the mobile phones of the employees and sent to the digital badges. Therefore, the employees need to download a dedicated application programs for the cartoonization processing, which will cause problems in the background, occupy the storage resources of the mobile phones of the employees and the computing resources of the processor, and affect the installation and operation of their work-related application programs (work-related application programs often occupy a large amount of space, such as mailbox, office software, etc.). Therefore, it is often difficult to promote the display of cartoonization profile pictures in this scenario, and the expected effect cannot be achieved.

Scenario 2: In a large conference, electronic table cards are prepared for attendees, which usually display the names of the attendees. In some conference themes, such as game conference themes or entertainment-oriented conference themes, the cartoonization profile pictures of the attendees can be displayed on the electronic table cards to increase the interest of the conference. However, there is currently no such implementation solution in the related art.

It can be seen that the above scenarios all have the problems described in the background. In view of this, the present disclosure provides an image processing method to solve the problems of the high performance requirements of the terminal, the occupation of a large amount of storage resources and computing resources of the processor when performing the cartoonization processing on the images. The core idea of this method is that: when performing the cartoonization processing on the target image, the cloud server can perform image segmentation on the target image, and when performing the cartoonization processing of the portrait, it can be performed by the terminal and/or the cloud server. In this way, the tasks of each stage of the portrait cartoonization process (image segmentation, portrait cartoonization, image fusion) are shared between the terminal and the cloud server, so that the part of the application program executed on the terminal can be significantly reduced, without occupying a large amount of storage resources and computing resources of the processor of the terminal, it may display cartoonization images on a large number of display devices with low performance while reducing the performance requirements on the terminal.

In this embodiment, cartoon refers to sketches and base images of murals, oil paintings, carpets, etc., and can also refer to comics, satirical paintings, and humorous paintings. In practice, it is to use concise and humorous, even satirical, painting language to tell stories. The cartoonization in the present disclosure refers to the process of transforming real person images into cartoon characters, so as to depict a real person image using cartoonish images.

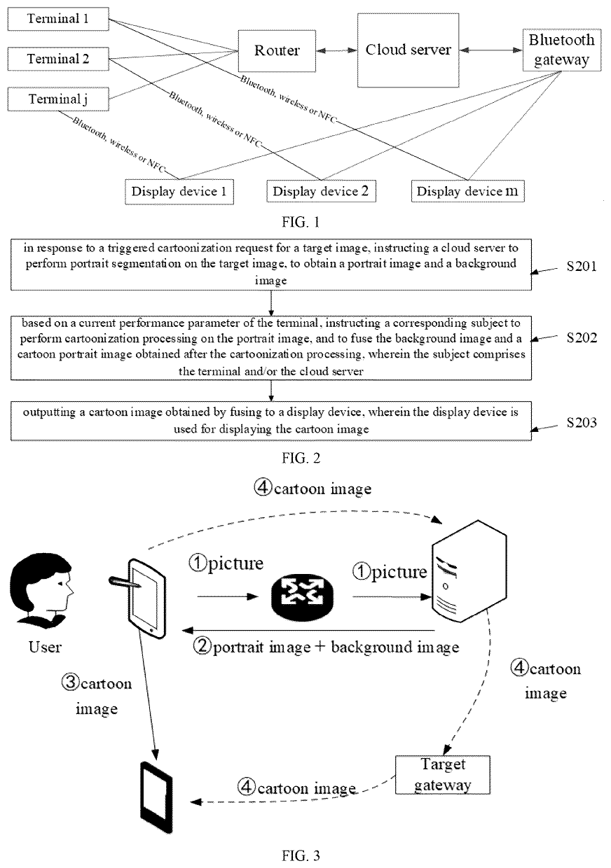

Referring to FIG. 1, a schematic diagram of a framework of an image processing system to which the image processing method is applied according to the present disclosure is shown. The image processing system may be applied to the above scenario 1 or scenario 2, as shown in FIG. 1, and may include a cloud server, a plurality of terminals, and a plurality of display devices.

Among them, the plurality of terminals may communicate and connect with the cloud server, specifically, the plurality of terminals are connected to the cloud server through a HTTP protocol; and the plurality of terminals may also communicate and connect with the plurality of display devices, among them, the terminals and the display devices may be connected through Bluetooth or near field communication (NFC). In the scenario 1, one terminal is correspondingly equipped with one display device, for example, one mobile phone is equipped with one electronic badge. In the scenario 2, there is no need for a one-to-one correspondence between the terminal and the display device, it is only necessary to establish a communication connection between the terminal and the display device when the cartoon image needs to be displayed on the display device, and then send the cartoon image to the display device. For example, when a user enters the venue with a mobile phone which establishes a Bluetooth communication connection with the electronic table card on the seat, a cartoon image is sent to the electronic table card to display own cartoon profile picture.

Among them, the cloud server can be connected to the plurality of display devices through a plurality of gateways, the plurality of gateways may include Bluetooth gateways and wireless communication gateways, so that the plurality of display devices can communicate with the cloud server through Bluetooth and other near network protocols. The display device can communicate with the cloud server through the Bluetooth gateway, and the terminal can communicate with the cloud server through the router. When the terminal is scanned by the router, the router reports the basic information of the terminal to the cloud server. When the display device is scanned by the Bluetooth gateways or the wireless gateways, the gateways report the connection information of the display device to the cloud server.

Among them, the connection information can include remaining power, an identifier of the display device, signal strength, etc. In the scenario 1, the terminal is used to initiate a cartoonization request for the target image, and the cloud server is used to perform portrait segmentation on the target image, obtaining a portrait image and a background image. Then, the cloud server and/or terminal performs cartoonization processing on the portrait image, and fuses the cartoon portrait image after the cartoonization processing with the background image to obtain the cartoon image. Ultimately, the cartoon image can be sent to the display device by the cloud server or the terminal.

In this embodiment, the cartoon image can be sent by the cloud server to the display device. For example, in the absence of a communication connection between the terminal and the display device, the cartoon image can be sent to the display device through the gateway between the cloud server and the display device.

Among them, the display device may include at least one of an electrophoretic display type (E-Paper, electrophoretic display technology) badge, a conference doorplate, and a conference table card. For example, it may include an electronic badge and an electronic table card, and in some cases, it may include the conference doorplate, or other types of display devices.

Among them, the terminal can be configured with an application program for executing cartoonization of the images, the application program can be a dedicated application for image cartoonization processing. Certainly, in practice, the image cartoonization can be a part of the many functions of the application program. For example, in the scenario 2, the application program can be a conference business application program, and its image cartoonization processing is only a part of its functionality.

Combined with the system shown in FIG. 1, the image processing method of the present disclosure is introduced. Referring to FIG. 2, a flowchart of steps of an image processing method in an embodiment is shown. In this embodiment, how to execute the image processing method is explained from the terminal side. Certainly, this embodiment is only illustrated as an example in the scenario 1 or the scenario 2, and can still be applied to other similar the scenarios, such as an image display scenario. As shown in FIG. 2, it can specifically include the following steps:

Step S201: in response to a triggered cartoonization request for a target image, instructing a cloud server to perform portrait segmentation on the target image, to obtain a portrait image and a background image.

In this embodiment, the cartoonization request for the target image can be triggered by the user on the terminal, or it can be triggered by the terminal after detecting a predetermined event, or it can be confirmed by the user after displaying a dialog box to the user when detecting the predetermined event. For example, in the scenario 2, the user needs to confirm attendance at the meeting in the application. After confirming the attendance at the meeting, the terminal detects the event confirming the attendance at the meeting and can automatically issue a cartoonization request, or pop up a dialog box to ask the user if he need to perform cartoonization processing on the attendee images. If the user confirms, the cartoonization request will be triggered.

In practice, the cartoonization requests are mainly aimed at performing the cartoonization on the portrait area in the target image, which means that the portrait needs to be cartoonized. Certainly, in some embodiments, cartoonization can also be performed on other objects, such as animals, plants, etc. Given the application scenario of the present disclosure, it mainly focuses on the cartoonization processing of the portraits.

Among them, the terminal can respond to the cartoonization request and send an image segmentation request to the cloud server. The image segmentation request can carry the target image or the identifier of the target image. This can instruct the cloud server to perform the image segmentation on the target image, or it can instruct the cloud server to extract the target image based on the identifier of the target image and perform the image segmentation.

Specifically, in the case where the cartoonization request carries the identifier of the target image, the cloud server can store the character images of multiple users, which means that the terminal of each user can send his own character image to the cloud server in advance. In this way, when the cloud server receives an image segmentation request, it can extract the target image based on the identifier of the target image. Among them, the identifier of the target image can be the user identifier of the user or the identifier of the target image.

For example, in the scenario 2 or the scenario 1, the users can upload their character images to the cloud server through their mobile phones. Then, when perform the cartoonization processing on the target image, an image segmentation request carrying an identifier may be sent to the cloud server. Based on the identifier, for example, according to the user identifier of user 1, the cloud server can call up the profile picture of the user 1 and then perform the image segmentation on the profile picture of the user 1.

In specific implementation, interface APIs related to executing the image segmentation function in the cloud server can be configured in the terminal. In this way, the terminal can respond to the cartoonization request, and call the portrait segmentation model of the cloud server through the API to perform the portrait segmentation on the target image through the portrait segmentation model. In this case, the portrait segmentation model can be configured in the cloud server, which is used to extract the portrait from the target image into the portrait image, thereby obtaining the background image and the portrait image.

Step S202: based on a current performance parameter of the terminal, instructing a corresponding subject to perform cartoonization processing on the portrait image, and to fuse the background image and a cartoon portrait image obtained after the cartoonization processing.

Among them, the subject includes the terminal and/or the cloud server.

In this embodiment, after segmenting the target image by the cloud server, it needs to perform the cartoonization processing on the portrait image. Specifically, since performing the cartoonization processing on the portrait image consumes a certain amount of computing resources, the current performance parameters of the terminal can be detected first to determine whether the current performance of the terminal is sufficient to meet the requirement of performing the cartoonization processing on the portrait image. If it is sufficient to meet the requirement of performing the cartoonization processing on the portrait image, the terminal performs the cartoonization processing on the portrait image and fuses the background image and the cartoon portrait image obtained after the cartoonization processing. If it is not sufficient to meet the requirement of performing the cartoonization processing on the portrait image, the cloud server can perform the cartoonization processing on the portrait image and fuse the background image and the cartoon portrait image obtained after the cartoonization processing. Alternatively, if it is not sufficient to meet the requirement of performing the cartoonization processing on the portrait image, the terminal and cloud server can jointly perform the cartoonization processing on the portrait image, and fuse the background image and the cartoon portrait image obtained after the cartoonization processing.

The current performance parameters of the terminal may include at least one of the available storage space parameter and available memory parameter of the terminal. Among them, the available storage space parameter can characterize the size of the remaining storage space of the terminal, and the available memory parameter can be used to characterize the remaining memory computing resources of the terminal.

When the remaining storage space or the remaining memory computing resources of the terminal are small, continuing to perform the cartoonization processing of the portrait images on the terminal may cause problems such as terminal lag and slow cartoonization processing. Therefore, the cloud server can participate in the process of performing the cartoonization processing on the portrait images and fusing the background image and the cartoon portrait image obtained after the cartoonization processing.

In some specific implementations, if the performance of the terminal is sufficient to support the cartoonization processing of the portrait images, a generative adversarial model may be configured in the application program and SDK is configured in the terminal. When the terminal performs the cartoonization processing of the portrait images, it can receive the portrait images and the background images sent by the cloud server. Next, the generative adversarial model deployed on the terminal is called through SDK to perform the cartoonization processing on the portrait images. And the terminal fuses the background image and the cartoon portrait image output by the generative adversarial model.

It should be noted that the present disclosure is based on the current performance parameters of the terminal to determine the subject executing the cartoonization processing. In practice, the current performance parameters of the terminal may be different in different cartoonization requests. Therefore, the subject executing the cartoonization processing may change. For example, the first time is executed by the terminal, the second time can be executed by the cloud server, and the third time can be jointly executed by the cloud server and the terminal. In this way, during the operation of the terminal, the cartoonization processing of the target image at each time can be adapted to the current performance of the terminal, thereby achieving dynamic terminal performance maintenance and ensuring the efficiency of image cartoonization.

Step S203: outputting a cartoon image obtained by fusing to a display device, wherein the display device is used for displaying the cartoon image.

After obtaining the cartoon image, the cartoon image can be sent to the display device. In some embodiments, as shown in FIG. 1, since both the terminal and the cloud server can be connected to the display device, in practice, the terminal can send the cartoon image to the display device, or the cloud server can send the cartoon image to the display device.

By adopting this implementation, the image segmentation on the target image can be performed through the cloud server. When performing the portrait cartoonization processing, the terminal and/or the cloud server can execute it based on the current performance parameters of the terminal, in order to achieve the cartoonization processing of the image to be compatible with the performance of the terminal. In this way, the application programs on the terminal can avoid carrying algorithms, models, etc. related to the image segmentation, and can avoid occupying the computing resources of the terminal for the image cartoonization. This reduces the performance requirements of the terminal and dynamically maintains the performance of the terminal, so that the terminal resources are not excessively occupied during the image cartoonization process, and the computing resources of the terminal can meet the needs of other application programs.

Secondly, since the tasks of each stage in the process of portrait cartoonization (image segmentation, portrait cartoonization, image fusion) can be allocated to both the terminal and cloud servers based on the terminal performance, and the image segmentation does not need to be performed by the terminal, this allows for a more refined process of the portrait cartoonization or the image fusion, allowing the terminal to focus on the processing of portrait cartoonization and enhance the interest of cartoonization.

By adopting the image processing method of the embodiment of the present disclosure, cartoon portraits can be displayed on a large number of display devices with low performance, which can broaden the interest application of portrait cartoons to display systems with a large number of display devices with low performance.

In some embodiments, the process of step S202 is introduced, that is, how to perform cartoonization of the present disclosure is explained. Since in the present disclosure, the executing subject for performing cartoonization processing on the portrait images and fusing the background image and the cartoon portrait image obtained after the cartoonization processing can be the terminal and/or the cloud server, the following three situations will be explained in practice:
situation 1: when the current performance parameter indicates that the terminal is at first-level performance, instructing the terminal to perform the cartoonization processing on the portrait image, and to fuse the background image and the cartoon portrait image obtained after the cartoonization processing;
situation 2: when the current performance parameter indicates that the terminal is at third-level performance, instructing the cloud server to perform the cartoonization processing on the portrait image, and to fuse the background image and the cartoon portrait image obtained after the cartoonization processing; and
situation 3: when the current performance parameter indicates that the terminal is at second-level performance, instructing the cloud server to perform the cartoonization processing on the portrait image, and instructing the terminal to fuse the background image and the cartoon portrait image obtained after the cartoonization processing.

Among them, the first-level performance is higher than the second-level performance, and the second-level performance is higher than the third-level performance.

In some embodiments, the current performance parameters may include the current remaining memory resource parameter of the terminal, which is used to reflect the current remaining memory of the terminal. In specific implementation, if the current remaining memory resource parameter of the terminal is less than or equal to the minimum remaining memory resource threshold, it indicates that the current remaining memory resources of the terminal are insufficient to complete the cartoonization processing of the portrait image. Therefore, it can be determined that the terminal is at the third-level performance, and the cloud server can perform the cartoonization processing on the portrait image and fuse the background image and the cartoon portrait image obtained after the cartoonization processing.

If the current remaining memory resource parameter of the terminal is greater than the minimum remaining memory resource threshold but less than the target remaining memory resource threshold, it indicates that the current remaining memory resource of the terminal can partially process the portrait image. Therefore, it can be determined that the terminal is at the second-level performance. The cloud server can then perform the cartoonization processing on the portrait image, and the terminal can fuse the background image and the cartoon portrait image obtained after the cartoonization processing.

If the current remaining memory resource parameter of the terminal is greater than or equal to the target remaining memory resource threshold, it indicates that the current remaining memory resource of the terminal can complete the entire cartoonization processing. Therefore, it can be determined that the terminal is at the first-level performance. The terminal can then perform the cartoonization processing on the portrait image and fuse the background image and the cartoon portrait image obtained after the cartoonization processing.

Among them, the minimum remaining memory resource threshold is less than the target remaining memory resource threshold.

Certainly, the above only provides optional examples for determining which performance level the terminal is at based on the current performance parameters. In practice, the current performance parameters can also include other performance parameters, such as the remaining power parameter, which can reflect the remaining power of the terminal. Generally speaking, processing tasks that involve a large amount of computation consumes more power. In practice, if the remaining power parameter indicates that the terminal cannot support the cartoonization processing, it can instruct the cloud server to execute it. In this case, the cloud server can also send the cartoon images to the display device. If the remaining power parameter indicates that the terminal can support the cartoonization processing, it can indicate the terminal to execute it. In this way, when the power of the terminal is low, minimizing the consumption of resources on the terminal to extend its battery life.

Among them, in the image segmentation, the image segmentation can be performed by the cloud server. In practice, as described in the above embodiments, the target image to be processed can be located in the image library of the cloud server or uploaded by the terminal.

In specific implementation, the target image can be sent to the cloud server in response to the cartoonization requests, to instruct the cloud server to perform the portrait segmentation on the target image. Alternatively, the attribute identifier of the target image can be sent to the cloud server in response to cartoon requests, to instruct the cloud server to perform the portrait segmentation on the target image with the attribute identifier in the image library.

The attribute identifier can be the image identifier of the target image in the above embodiment, or the user identifier of the user to which the target image belongs, to be used to uniquely identify the target image.

For example, in the scenario 2, the participant is Li and his ID photo needs to be cartoonized, Li has already uploaded his ID photo to the cloud server beforehand, the terminal can send the user identifier of Li to the cloud server, and the cloud server then searches for the ID photo of Li based on the user identifier of Li to perform cartoonization on the ID photo. By adopting this implementation, it may instruct the cloud server to perform the cartoonization on the target images stored on the cloud server without storing the target images on the terminal, thereby optimizing the application scenario of the present disclosure.

In step S203, the terminal can send the cartoon image to the display device, or the cloud server can send the cartoon image to the display device. In some embodiments, the current communication state between the terminal and the display device can be detected to determine whether the terminal can successfully send the cartoon image to the display device. If so, the terminal is used to send the cartoon image. If not, the cloud server is used to send the cartoon image.

During specific implementation, the current communication state with the display devices can be detected. And based on the current communication state, the terminal or the cloud server can be instructed to send the cartoon image to the display device.

Among them, the current communication status between the terminal and the display device can refer to the Bluetooth communication state or the wireless communication state between the terminal and the display device. Specifically, it can detect whether there is a Bluetooth connection or wireless connection between the terminal and the display device to determine whether the terminal can normally communicate with the display device. Alternatively, it can determine whether the communication connection between the terminal and the display device is normal based on the Bluetooth signal strength and wireless signal strength between the terminal and the display device. For example, if the Bluetooth signal strength is weak and the wireless signal strength is also weak, the terminal cannot normally communicate with the display device. If either the Bluetooth signal strength or the wireless signal strength is strong, for example, exceeding the preset signal strength, the terminal can normally communicate with the display device.

In the case where the terminal cannot normally communicate with the display device, the terminal can instruct the cloud server to send the cartoon image to the display device.

Specifically, if the cloud server performs the fusion of the background image and the cartoon portrait image, in this case, the application program on the terminal can pop up the dialog box to ask whether to confirm to send the cartoon image by the cloud server, and respond to the confirmation operation of the user for the content in the dialog box. If the user clicks yes, the terminal sends the cartoon image sending request to the cloud server, and the cloud server sends its fused cartoon image to the display device based on the cartoon image sending request.

Specifically, if the terminal performs the fusion of the background image and the cartoon portrait image, in this case, the cartoon image is located on the terminal, and the application program on the terminal can still pop up the dialog box to ask whether to confirm to send the cartoon image by the cloud server, and respond to the confirmation operation of the user for the content in the dialogue box. If the user clicks yes, the terminal sends the cartoon image and the sending request to the cloud server. The cloud server receives the cartoon image and then sends it to the display device.

Among them, when the terminal normally communicates with the display device, the terminal can send the cartoon images to the display device.

Specifically, if the cloud server performs the fusion of the background image and the cartoon portrait image, the terminal can receive the cartoon images returned by the cloud server in advance and directly send the cartoon images to the display device. If the terminal performs the fusion of the background image and the cartoon portrait image, in this scenario, as long as it is determined that the terminal normally communicates with the display device, the cartoon image can be directly sent to the display device.

In some embodiments, it may also determine whether the display device is in a preset distance range based on the communication state between the terminal and the display device. In this way, when the distance between the terminal and the display device is not very far, the terminal can still send the cartoon images to the display device, to avoid the problem of increased communication costs caused by forwarding the cartoon images by the cloud server.

In specific implementation, it may determine whether the display device is in the preset distance range based on the communication state between the terminal and the display device. If yes, that is, the display device is in the preset distance range, the cartoon image is sent to the display device based on communication connection with the display device; and if the display device is not in the preset distance range, the cloud server is instructed to send the cartoon image to the display device through a target gateway at a location of the display device.

In this embodiment, it may determine whether the display device is in the preset distance range based on the strength of the communication signal between the terminal and the display device. For example, the minimum communication signal strength in the preset distance range can be set.

If the communication signal strength is higher than the minimum communication signal strength, it indicates that the display device is in the preset distance range of the terminal. In this case, even if there is a certain distance between the display device and the terminal, the user can hold the terminal close to the display device to send the cartoon image. In some specific implementations, when it is monitored that the display device is in the preset distance range and the communication signal strength is insufficient to successfully send the cartoon image, a prompt box can pop up, and the content of the prompt box can be “Please approach the display device” to prompt the user to hold the terminal close to the display device. For example, in the scenario 1, the terminal is the mobile phone, and the signal strength between the mobile phone and the electronic badge is weak but still in the preset distance range. At this time, a prompt box “Please approach the display device” can pop up on the terminal. By reducing the distance between the mobile phone and the electronic badge, the signal strength can be enhanced, and the cartoon image can be sent to the electronic badge.

If the communication signal strength is lower than the minimum communication signal strength, it indicates that the display device is not in the preset distance range of the terminal. In this case, there may not be a communication connection between the two, or there may be a communication connection, but the strength is weak, and it cannot allow the user to approach the display device in a short period of time. Therefore, the cloud server can be instructed to send the cartoon images to the display device.

Among them, when the cloud server sends the cartoon images to the display device, due to the communication connection between the cloud server and the display device through a gateway, and the gateway is generally deployed in a fixed location, in this case, the target gateway connected to the display device can be determined. Then, the cloud server sends the cartoon images to the target gateway, to send them to the display device through the target gateway.

For example, in the scenario 1, the terminal is the mobile phone, and the user with the mobile phone has not yet entered the company. The electronic badge is stored at his own workstation, the signal strength between the mobile phone and the electronic badge is very weak, and the electronic badge is not in the preset distance range. At this time, a prompt box “Is it sent by the cloud server” can pop up on the mobile phone to respond to confirmation of the user. The mobile phone sends the cartoon image to the cloud server, and then the cloud server finds the target gateway at the workstation and sends the cartoon image to the target gateway. The target gateway sends the cartoon image to the electronic badge, so that the user can see the electronic badge with the cartoon image displayed when the user arrives at the workstation.

Certainly, in some embodiments, such as the communication environment shown in FIG. 1 above, the communication connection includes at least one of Bluetooth, wireless, and near-field communication, and the gateway may include a Bluetooth gateway and/or a wireless communication gateway.

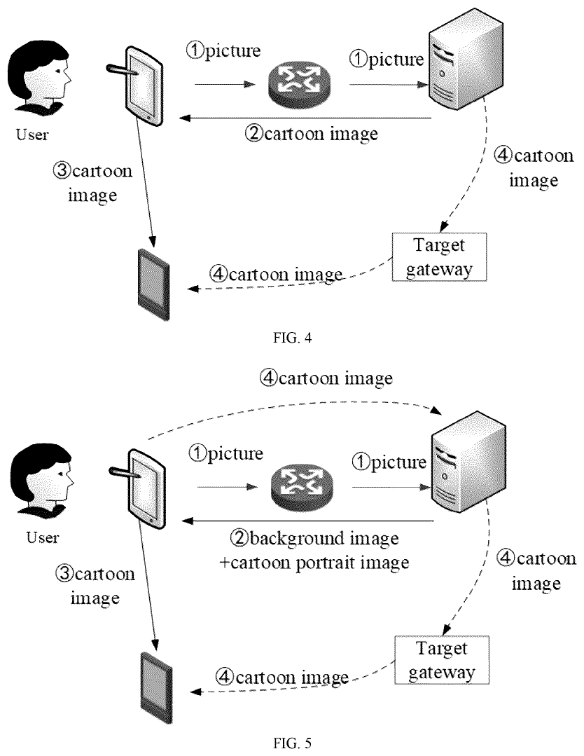

Below, referring to FIG. 3, FIG. 4, and FIG. 5, taking the terminal as the mobile phone and the display device as the electronic badge as examples, several application examples of the image processing method of the present disclosure are illustrated. Specifically, the near-field communication is used between the electronic badge and the mobile phone, and the electronic badge can also communicate with the cloud server through the gateway. The following are introduced:

Example 1: As shown in FIG. 3, the user uploads his own mobile photo on his mobile phone and clicks on cartoonization. The mobile phone sends the photo to the cloud server, the cloud server performs image matting and returns the portrait and background images obtained by the image matting to the mobile phone for the cartoonization processing, to obtain the cartoon image. If the electronic badge is right beside the user, the process is shown by the dashed arrow in FIG. 3, where the mobile phone approaches the electronic badge through the near-field communication and transmits the cartoon image to the electronic badge for display.

If the electronic badge is not beside the user and cannot be approached for a short period of time, it can be determined to be sent by the cloud server. The process is shown by the dashed arrow in FIG. 3, which is to send the cartoon image to the cloud server. The cloud server finds the target gateway where the electronic badge is located, and sends the cartoon image to the target gateway, and the target gateway transmits the cartoon image to the electronic badge for display through Bluetooth or wireless means.

Example 2: as shown in FIG. 4, the user uploads his own photo on his mobile phone, then clicks on cartoonization. The mobile phone directly uploads the photo to the cloud server, the cloud server performs image matting on the image and performs the cartoonization processing, and then sends the obtained cartoon image to the mobile phone. The mobile phone sends the cartoon images in the way of the example 1 above.

Alternatively, the cloud server can directly send the obtained cartoon image to the target gateway, which then transmits the cartoon image to the electronic badge to display via Bluetooth or wireless means, as indicated by the dashed arrow in FIG. 4.

Example 3: as shown in FIG. 5, the user uploads his own photo on his mobile phone and clicks on cartoonization. The mobile phone directly uploads the photo to the cloud server, the cloud server then performs image matting on the image and performs cartoonization processing on the portrait image obtained by the image matting. The background image and the cartoon portrait image obtained after the cartoonization processing are then sent to the mobile phone, which performs fusion to obtain the cartoon image.

Afterwards, the mobile phone sends the cartoon image in the way of the example 1.

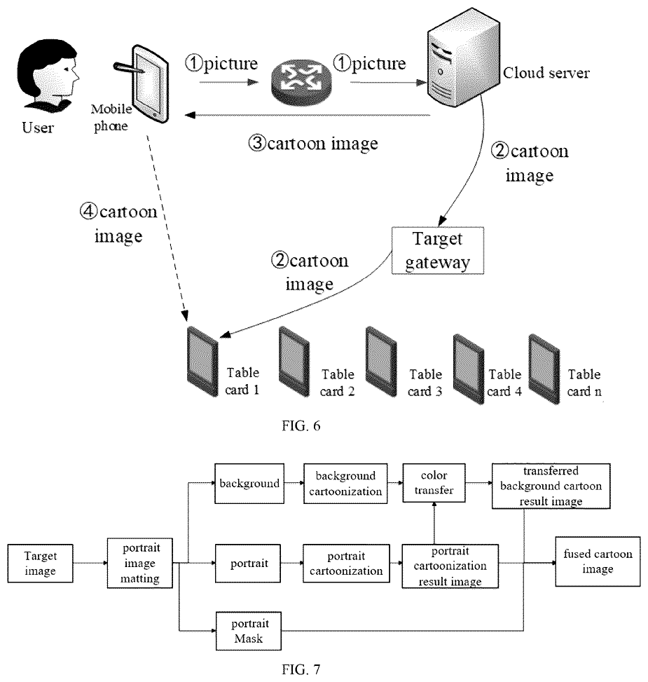

Below, referring to FIG. 6, there are scene diagrams of application examples of the image processing method, which takes the terminal as the mobile phone and the display device as the electronic table card as an example. Specifically, near-field, Bluetooth, or wireless communication is used between the electronic table card and the mobile phone, and the electronic table card can also communicate with the cloud server through the gateway.

Example 4: as shown in FIG. 6, the user needs to attend conference 1. In advance, the user uploads his own photo to the cloud server on his mobile phone, and then clicks on the cartoonization option (indicating that the user has a need to display his photo in a cartoonization manner). The mobile phone directly uploads the image identifier to the cloud server. The cloud server finds the target image, performs image matting, and performs cartoonization processing on the portrait image obtained by the image matting. Then, the background image and the cartoon portrait image obtained after the cartoonization processing are fused and sent to the mobile phone, which can save the cartoon image.

At the same time, the cloud server sends the fused cartoon image to the corresponding electronic table card through the target gateway. It should be noted that at this time, the electronic table card is the one that the user needs to sit on when attending the conference.

When the user enters the venue and finds that his cartoon image is not displayed on the electronic table card, they can open their mobile phone to establish a Bluetooth communication connection with the electronic table card and send the cartoon image to the electronic table card for display. Alternatively, they can open their mobile phone to communicate with the electronic table card through near-field communication and send the cartoon image to the electronic table card for display.

In this scenario, although the users have not yet arrived at the venue, they can upload their own image to the cloud server for cartoonization processing when uploading their conference information. In this way, when the users have arrived at the conference venue, they can see the electronic table card with their cartoon images displayed, enhancing the interest of the user participation.

When adopting this implementation, the cartoonization of the images can be achieved without being limited by the performance of the terminal or the environment in which the user is located, and cartoon images can be displayed on the display device, thereby expanding the coverage of the application scenarios and optimizing the user experience.

Below, how to perform the cartoonization processing on the portrait images in the present disclosure, as well as the fusion of the cartoon portrait images and the background images is introduced.

Referring to FIG. 7, a schematic diagram of the overall process of the cartoonization processing of the target image in the present disclosure is shown. As shown in FIG. 7, the cartoonization processing of the target image includes image segmentation, namely the portrait image-matting stage, the portrait cartoonization stage, the background cartoonization stage, and the fusion stage in FIG. 7.

Among them, for the portrait image-matting stage, as described in the above embodiment, it can be executed by the cloud server. In specific implementation, the image segmentation can be performed using a segmentation model in related art, such as training a dedicated portrait segmentation model based on the open-source saliency detection model U2Net, which will not be repeated here.

Among them, for the portrait cartoonization stage, an adversarial network can be trained to obtain a generative adversarial network model, which can be used to generate the cartoon portrait images of the portrait images.

Next, the cartoon portrait image can be used to perform color transfer on the background image. The portrait cartoonization result image shown in FIG. 7 is the cartoon portrait image of the present application. Afterwards, the transferred background cartoon result image is obtained, which is the background cartoon image of the present application. Then, the cartoon portrait image and the background cartoon image are fused to obtain the cartoon image.

In specific implementation, the portrait image can be input into the generative adversarial network model to perform the cartoonization processing on the portrait image. Next, the cartoon portrait image output from the generative adversarial network model is obtained.

The training process of the generative adversarial network model can be as follows:
building a generative adversarial network based on the U-GAT-IT network, using unpaired cartoon image samples and character image samples as sample pairs, and training the U-GAT-IT network-based generative adversarial network to obtain the generative adversarial network for performing portrait cartoonization.

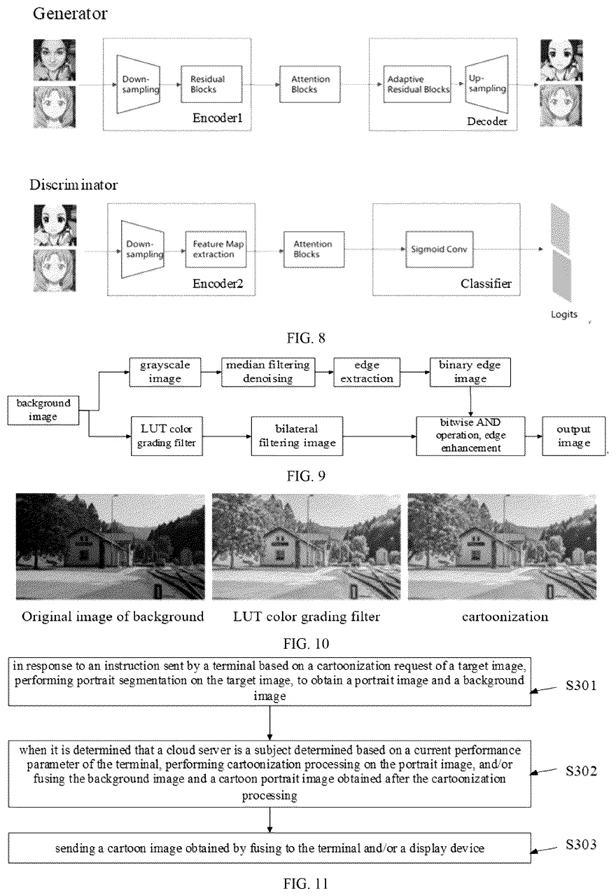

Referring to FIG. 8, a training schematic diagram of the generative adversarial network is shown, as shown in FIG. 8, the generative adversarial network includes a generator 801 and a discriminator 802. The generator is used to generate the cartoon images of the character image samples based on the cartoon image samples, and the discriminator is used to distinguish the distance between the cartoon image samples and the cartoon images of the character image samples. During training, the parameters of the generative adversarial network can be adjusted based on this distance. After multiple parameter adjustments, the training is completed to obtain the generative adversarial network for inference.

In some embodiments, in order to integrate the model at the terminal, the network layers can be streamlined during model training, and Uint8 training can be added to enable the model capable to perform inference at the terminal.

Among them, the sample data for training the generative adversarial network model can include: image samples of real person profile pictures, as well as cartoon character profile pictures of different styles. Among them, a sample pair can include the image samples of the real person profile pictures and the cartoon character profile picture samples of any style. It should be noted that the image samples of real person profile pictures of the same person can be combined with multiple styles of cartoon character profile pictures to obtain multiple sample pairs of different cartoon styles. In this way, a small number of real person profile pictures can be used to train the generative adversarial network that can generate different cartoon style portrait images. Since the image samples of the real person profile pictures mentioned above are obtained through corresponding user authorization, the collection quantity of the image samples of the real person profile pictures can be reduced, avoiding the problems of difficult permission acquisition and data security not being guaranteed involved in collecting a large number of image samples of the real person profile pictures.

Among them, for the fusion stage, in one case, the cartoon portrait image and the background image can be directly fused, that is, the original background image and the cartoon portrait image can be fused. When fusing, the background image can be first color transferred based on the cartoon portrait image to unify the styles of the background image and the cartoon portrait image, and increase the image harmony of the fused cartoon image.

In some embodiments, a target style in the background image can be transferred based on style information of the target style in the cartoon portrait image, to obtain a cartoonization background image; and the cartoonization background image and the cartoon portrait image are fused to obtain the cartoon image.

Among them, the target style at least includes a color style.

In this embodiment, when the target style includes the color style, the style information may refer to color information. In some embodiments, the color information may be RGB color information, where R represents red, G represents green, and B represents blue.

When performing style transfer, the color values of the three color channels of RGB in the background image can be adjusted based on mean and standard deviation of the color values of the three color channels of RGB in the cartoon portrait image, so that the mean and standard deviation of the color values of the three color channels of RGB in the background image are consistent with those of the color values of the three color channels of RGB in the cartoon portrait image. That is to say, the mean and standard deviation of the color values of the R channel in the background image are consistent with those of the color values of the R channel in the cartoon portrait image, and the same applies to the B channel and G channel.

When adjusting, it can be to adjust the color values of each pixel in the background image in the other three color channels of RGB to achieve the above purpose. Among them, color adjustment can be detailed in the related art, and will not be repeated here.

In some embodiments, when performing color transfer, the cartoon portrait image and the background image are converted to lab color space, and the colors of each color channel of the cartoon portrait image are transferred to the corresponding color channel of the background image in the lab color space, so as to convert the color-transferred background image to RGB color space, to obtain a cartoonization background image.

In specific implementation, the cartoon portrait image is converted to the lab color space to obtain a first image, and the background image is converted to the lab color space to obtain a second image; a value of each pixel in a corresponding channel of the second image is corrected based on mean and standard deviation of each pixel in each channel of the first image; and then, the corrected second image is converted to the RGB color space to obtain the cartoonization background image.

In this embodiment, the lab color space is based on people's perception of colors. The values in the Lab describe all colors that a person with normal vision can see. Because Lab describes the display mode of colors, rather than the quantity of specific pigments required by devices (such as monitors, desktop printers, or digital cameras) to generate colors, Lab is considered a device-independent color model.

The Lab color model consists of three elements, that is, brightness (L), and a and b related to colors. In this embodiment, one element is referred to as one color channel. L represents luminosity, a represents the range from magenta to green, and b represents the range from yellow to blue. The value range of L is from 0 to 100, and when L=50, it is equivalent to 50% black. The value range of a and b is from +127 to −128, where +127a is red and it turns green when gradually transitioning to −128a. By the same principle, +127b is yellow, and −128b is blue. All colors are composed of these three values that interact and change.

For example, the Lab value of a color is L=100, a=30, and b=0, this color is pink. It should be noted that the color of the a-axis and b-axis in this mode is different from RGB. The magenta is more reddish, the green is more greenish, the yellow is slightly reddish, and the blue is slightly cyan.

Among them, the mean and standard deviation of each pixel in each color channel of the lab color space in the first image and the second image can be calculated respectively. The standard deviation can be the variance. For example, the mean and standard deviation of the values of the element L for each pixel in the first image can be determined, and the mean and standard deviation of the values of the element L for each pixel in the second image can be determined. Similarly, the mean and standard deviation of the values of the element a and the element b for each pixel in the first image can be obtained, and the mean and standard deviation of the values of the element a and the element b for each pixel in the second image can be obtained.

Then, according to the mean and standard deviation corresponding to the elements L, a, and b of each pixel in the first image, the mean and standard deviation corresponding to the elements L, a, and b of each pixel in the second image is adjusted.

The adjustment process can be carried out according to the following migration formula (1):

$${I}_{k} = \frac{{σ}_{t}^{k}}{{σ}_{s}^{k}} ( {S}_{k} - {μ}_{s}^{k} ) + {μ}_{t}^{k} \qquad formula ( 1 )$$

Among them, Iₖ represents the pixel value of the adjusted background image in the k-th channel, k represents the k-th channel, k=l or a or b;

$${μ}_{s}^{k}$$

represents the mean of the cartoon portrait image in the k-th channel,

$${μ}_{t}^{k}$$

represents the mean of the background image in the k-th channel,

$${σ}_{s}^{k}$$

represents the standard deviation of the cartoon portrait image in the k-th channel, and

$${σ}_{t}^{k}$$

represents the standard deviation of the background image in the k-th channel.

Among them, after color transfer in the lab color space, the corrected second image can be converted to the RGB color space, where R represents red, G represents green, and B represents blue. The RGB color space is the most important and common color model for image processing, which can facilitate the fusion with the cartoon portrait images in the same color space when fusing subsequent images.

As a result, the color transfer in the lab color space can be achieved. Since the lab color space is closer to the colors perceived by users, the color style of the cartoon portrait images can be transferred to the background image, so that the color style between the background image and the cartoon portrait image is unified, improving the color compatibility between the two and avoiding the problem of too much difference in style between the fused cartoon portrait image and background image, which affects the viewing experience.

As shown in FIG. 7, when fusing the background images and the cartoon portrait images, initial cartoonization processing can be performed on the background image, and then the color of the cartoon portrait image can be transferred to the initial cartoonized background image, and then the fusion is performed.

That is to say, after performing cartoonization on the background image, the initial cartoonized background image is obtained. Then, based on the style information of the target style in the cartoon portrait image, the target style in the initial cartoonized background image is transferred to obtain the cartoonization background image. Finally, the cartoonization background image and the cartoon portrait image are fused to obtain the cartoon image.

In some embodiments, performing cartoonization processing on the background image may include:
sharpening object edges in the background image to obtain an edge image, and adjusting color brightness of the background image to obtain a color-adjusted image; and performing edge enhancement on edges of the color-adjusted image based on the edge image to obtain an initial cartoonized background image.

In this embodiment, the cartoonization processing of the background image can refer to adjusting the edge contours and color brightness of the background image to conform to the style of the cartoon image. Specifically, sharpening the object edges in the background image can be achieved by binarizing the edges to obtain a binarized edge map; adjusting the color brightness in the background image can be achieved by adjusting the color using a Look Up Table (LUT) color grading filter and enhance color saturation, contrast, and brightness, resulting in bright colors. Then, bilateral filtering is applied multiple times to the bright image to obtain a color-adjusted image.

Referring to FIG. 9, a flowchart of the initial cartoonization processing for the background image is shown. In some embodiments, median filtering denoising can be used to first perform median filtering denoising processing on the background image. Then, edge extraction can be performed on the image after the median filtering denoising processing. The edge extraction can be achieved by using Canny edge extraction or Laplacian operator edges to obtain the edge image. Finally, the edge image can be binarized for sharpening to obtain the edge image.

Among them, the LUT color grading filter can be used to adjust the color of the background image, enhancing the color saturation, contrast, and brightness. Then, bilateral filtering can be applied multiple times to the bright image to obtain the color-adjusted image.

Among them, edge enhancement can be applied to the edges in the color-adjusted image based on the edge image. During the enhancement, the edges can be enhanced pixel by pixel, for example, the edge enhancement is performed by using the bitwise AND operation as shown in FIG. 9, to obtain the initial cartoonized background image.

When performing the initial cartoonization on the background image in the above embodiment, since it only involves processing the background image using algorithms, these algorithms do not occupy a lot of computing resources on the terminal, and subsequent color transfer is also to process the color values of pixels, which does not occupy a lot of computing resources on the terminal. Even if the cartoonization of the background image is performed on the terminal, it will not impose high performance requirements on the terminal. This allows the terminal to free up more computing resources for cartoonization processing of the portrait images, thereby providing sufficient performance space for improving the precision and interest of the cartoonization of the portrait images.

Referring to FIG. 10, a schematic diagram of the image processing effect of the above process is shown. As shown in FIG. 10, the LUT color grading filter can be used to modulate the color brightness and saturation of the background image. When performing the edge enhancement based on the edge image, the edges in the color-adjusted image can be enhanced according to the style effect of the cartoonish edge lines, so that the background image conforms to the cartoonish style.

Among them, for the image fusion stage, when fusing the cartoonization background images and cartoon portrait images, mask images can be used for fusion.

In some embodiments, a mask image for the target image output by the cloud server is obtained and noise suppression is performed on the mask image; the background image and cartoon portrait image is fused based on the mask image after the noise suppression; among them, the mask map is used to identify a foreground area and a background area in the target image.

In this embodiment, the foreground area can be the area where the portrait image is located, and the background area can be the area where the background image is located. In specific implementation, the noise suppression of the mask image can refer to applying Gaussian smoothing filtering to the mask image to make the synthesized edges smoother.

Among them, when fusing the background images and the cartoon portrait images based on the mask images after the noise suppression, fusion can be performed according to weights. Specifically, fusion can be performed according to the following formula (2):

$$dst = portait cartoon image * Mask + background image * ( 1 - Mask ) . \qquad formula ( 2 )$$

Where dst is the fused cartoon image, and Mask is the mask image. Among them, during fusion, pixel by pixel fusion can be performed. That is to say, for the pixel belonging to the foreground area in the mask image, the value of the pixel corresponding to the same position in the cartoon portrait image is multiplied by the value of this pixel, so that the obtained pixel value is used as the value of the pixel at corresponding position in the fused cartoon image.

Similarly, for the background image, for the pixels belonging to the background area in the mask image, the value of the pixel is multiplied with the value of the pixel corresponding to the same position in the background image, so that the obtained pixel value is used as the value of the pixel at the corresponding position in the fused cartoon image.

Certainly, in some fusion processes, in order to highlight the differences between the portrait and the background, background blurring or portrait blurring can be performed. In this way, corresponding weights can be set for the background image and the cartoon portrait image during fusion, and then fusion can be performed based on the weights. For example, in the formula (2) above, the weight corresponding to the portrait cartoon image can be set to «, and the weight corresponding to the background image can be set to B. Based on these weights, the background image or the cartoon portrait image can be weakened to achieve the corresponding background blurring or portrait blurring effect after fusion.

Based on the same inventive concept, the present disclosure provides an image processing method from the cloud server side. Referring to FIG. 11, a flowchart of the steps of an image processing method is shown. As shown in FIG. 11, the method is applied to the cloud server and can specifically include the following steps:
Step S301: in response to an instruction sent by a terminal based on a cartoonization request of a target image, performing portrait segmentation on the target image, to obtain a portrait image and a background image;
Step S302: when it is determined that a cloud server is a subject determined based on a current performance parameter of the terminal, performing cartoonization processing on the portrait image, and/or fusing the background image and a cartoon portrait image obtained after the cartoonization processing; and
Step S303: sending a cartoon image obtained by fusing to the terminal and/or a display device.

In this embodiment, the instruction sent by the terminal based on the cartoonization request of the target image can be the image segmentation request described in the above embodiment, the image segmentation request can carry the target image or the identifier of the target image. The cloud server can respond to the image segmentation request and perform portrait segmentation on the target image to obtain the portrait image and the background image.

Among them, a portrait segmentation model can be pre-configured in the cloud server to perform the portrait segmentation of the target image.

Among them, when the terminal determines that the cloud server performs part or all of the cartoonization of the image based on the current performance parameters, the cloud server can perform the cartoonization processing on the portrait image and/or fuse the background image and the cartoon portrait image obtained after the cartoonization processing. Specifically, when the cloud server performs all of the cartoonization of the image, the cloud server can perform the cartoonization processing on the portrait image and fuse the background image and the cartoon portrait image obtained after the cartoonization processing. When the cloud server performs part of the cartoonization of the image, the cloud servers can perform the cartoonization processing on the portrait images and send the cartoon portrait image obtained after the cartoonization processing to the terminal, the terminal then fuses the background image and the cartoon portrait images.

Among them, the cloud server can obtain the cartoon images. Specifically, when the cloud server performs all of the cartoonization of the image, the cloud server can generate the cartoon images. When the cloud server performs part of the cartoonization of the image, the cloud server can receive the cartoon images uploaded by the terminal.

Among them, when it needs the cloud server to send the cartoon image to the display device, for example, if the terminal cannot communicate with the display device, the cloud server can send the cartoon image to the display device. When there is no need for the cloud server to send the cartoon image to the display device, for example, if the terminal can communicate with the display device, the cloud server can send the cartoon image generated by itself to the terminal.

In this embodiment, in the cartoonization processing of the target image, the cloud server can be instructed by the terminal to perform the image segmentation on the target image. When performing portrait cartoonization processing, the cloud server can also complete tasks of at least one stage of the portrait cartoonization process (image segmentation, portrait cartoonization, image fusion) based on the current performance parameters of the terminal. Therefore, the cloud server can share the cartoonization processing task. In this way, the application programs on the terminal can avoid carrying algorithms, models, etc. related to the image segmentation, so as not to occupy a lot of storage resources and computing resources of the processor of the terminal, thereby reducing the performance requirements on the terminal.

Among them, when the cartoon image is sent to the display device by the cloud server, it can receive connection information uploaded by a plurality of gateways, the connection information includes the device identifier of the devices connected to the gateways; and determine the target gateway connected to the display device based on the connection information; afterwards, send the cartoon image to the target gateway to instruct the target gateway to send the cartoon image to the display device.

In this embodiment, one gateway can be correspondingly connected to one or more display devices, and the gateway can periodically upload its connection information to the cloud server. The connection information includes the device identifiers of the display devices connected to the gateway. In this way, based on the device identifiers of the display devices, the gateway to which the display device to display the cartoon image is connected can be determined, that gateway is the target gateway. The cloud server can then send the cartoon image to the target gateway, so that the target gateway can send the cartoon image to the display device.

Among them, as described in the embodiments on the terminal side above, the gateway includes the Bluetooth gateway and/or the wireless communication gateway. The cartoon image to be sent can be sent from the terminal to the cloud server, or it can be obtained by the cloud server after the cartoonization processing of the portrait image and fusion of the background image and the cartoon portrait image obtained after the cartoonization processing.

In some embodiments, in the process of determining the target gateway, in order to improve the success rate of sending the cartoon image to the display device, the cartoon image can be sent to the target gateway having the strongest communication signal with the display devices.

In specific implementation, when there is one gateway connected to the display device, that gateway can be used as the target gateway; when there are multiple gateways connected to display devices, the signal strength between the display devices and each gateway is obtained, and the target gateway is determined based on the signal strength.

Among them, if the display device is only connected to one gateway, that is, only one gateway detects the display device and connects to the display device, then that gateway can be used as the target gateway.

Among them, if the display device is connected to multiple gateways, that is to say, multiple gateways have detected the display device and connected to the display device. For example, in Bluetooth communication, if multiple gateways have detected and connected to the display device, the signal strength corresponding to each gateway can be determined, and the gateway with the strongest signal strength can be regarded as the target gateway, so that the target gateway can successfully send the cartoon image to the display device.

Below is a schematic explanation of the complete process of an image processing method of the present disclosure, from the perspective of terminals and servers, which can specifically include the following steps:
S1: the terminal responds to the triggered cartoonization request for the target image, calls the portrait segmentation model of the cloud server through the API, and sends the target image to the cloud server to perform the portrait segmentation on the target image through the portrait segmentation model, to obtain the portrait image and the background image;
S2: the terminal detects its current performance parameters, and if the performance parameter indicates that the terminal is at the first-level performance, proceeding to step S3; if the performance parameter indicates that the terminal is at the second-level performance, proceeding to step S5; and if the performance parameter indicates that the terminal is at the third-level performance, proceeding to step S7;
S3: the terminal requests the portrait image and the background image from the cloud server, that is, receives the portrait image and the background image returned by the cloud server, performs cartoonization processing on the portrait image, and fuses the background image and the cartoon portrait image obtained after the cartoonization processing, to obtain the cartoon image;
S4: after detecting the generation of the cartoon image, the terminal detects the communication state with the display device; if the communication state indicates normal communication, proceeding to step S401; if not, proceeding to step S402;
S401: the terminal sends the cartoon image to the display device;
S402: the terminal encapsulates the cartoon image and sends it to the cloud server;
S403: after receiving the cartoon image, the cloud server determines the target gateway connected to the display device and sends the cartoon image to the target gateway, so that the target gateway sends the cartoon image to the display device;
S5: the terminal requests the cloud server to perform the cartoonization processing on the portrait image, the cloud server responds to the request by performing the cartoonization processing on the portrait image, and returns obtained cartoon portrait image to the terminal; and the terminal then fuses the background image and the cartoon portrait image to obtain the cartoon image;
S6: after detecting the generation of the cartoon image, the terminal detects the communication state with the display device; if the communication state indicates normal communication, proceeding to step S401; if not, proceeding to step S402;
S7: the terminal requests the cloud server to perform the cartoonization processing and the fusion processing on the portrait image; in response to the request, the cloud server performs the cartoonization processing on the portrait image, fuses the background image and the cartoon portrait image, and obtains the cartoon image;
S8: after detecting the generation of the cartoon image, the cloud server first sends the cartoon images to the terminal for retrieval;
S9: after receiving the cartoon image, the terminal detects the communication state with the display device; if the communication state indicates normal communication, proceeding to step S901; if not, proceeding to step S902;
S901: the terminal sends the cartoon image to the display device;
S902: the terminal sends an image sending request to the cloud server; and
S903: the cloud server responds to the image sending request, determines the target gateway connected to the display device, and sends the cartoon image to the target gateway, so that the target gateway sends the cartoon image to the display device.

The image processing method in the above embodiments has the following advantages:

First, the cloud server performs image segmentation on the target image, when performing portrait cartoonization processing, it can be performed by the terminal and/or the cloud server, so that the tasks in each stage of the portrait cartoonization process can be shared between the terminal and the cloud server. Therefore, it allows application programs on the terminal to not be equipped with algorithms and models related to the image segmentation, and can also crop out algorithms and models related to the portrait cartoonization, thereby reducing the performance requirements on the terminal.

Second, the image segmentation task is executed by the cloud server, it reduces the cost of the application programs for the image processing, allowing the application programs to focus their program expenses on the portrait cartoonization, that is, on the generative adversarial network. This enables the terminal to focus on the portrait cartoonization processing and improve the interest effect of the cartoonization processing.

Third, when performing the cartoonization processing on the portrait image based on the current performance parameters of the terminal, if the current performance of the terminal is insufficient to support the cartoonization processing on the portrait image, the cloud server can perform the cartoonization processing on the portrait image. If the current performance of the terminal is sufficient to support the cartoonization processing on the portrait image, the terminal can handle the cartoonization processing on the portrait image. This way, the cartoonization of the images can be adapted to the performance of the terminal. While achieving the cartoonization of the images, it can fully adapt to the performance of the terminal without occupying too many computing resources, thereby not affecting the use and operation of other application programs on the terminal.

Fourth, when sending the cartoon image to the display device, they can be sent by the terminal through near-field communication or Bluetooth communication, or by the cloud server through the gateway. This can increase the probability of successfully sending the cartoon image to the display device and ensure that the cartoon image is displayed on designated devices.

Fifth, color transfer can be performed on the background image based on the cartoon portrait image to unify their styles, thereby improving the color compatibility between the two and avoiding significant differences in style between the fused cartoon portrait image and the background image.

Sixth, the cartoonization of the portrait image is performed by the generative adversarial network, which can enrich the cartoonization types of the portrait images based on the characteristics of the generative adversarial network, and thus obtain the cartoon portrait image with high cartoonization quality.

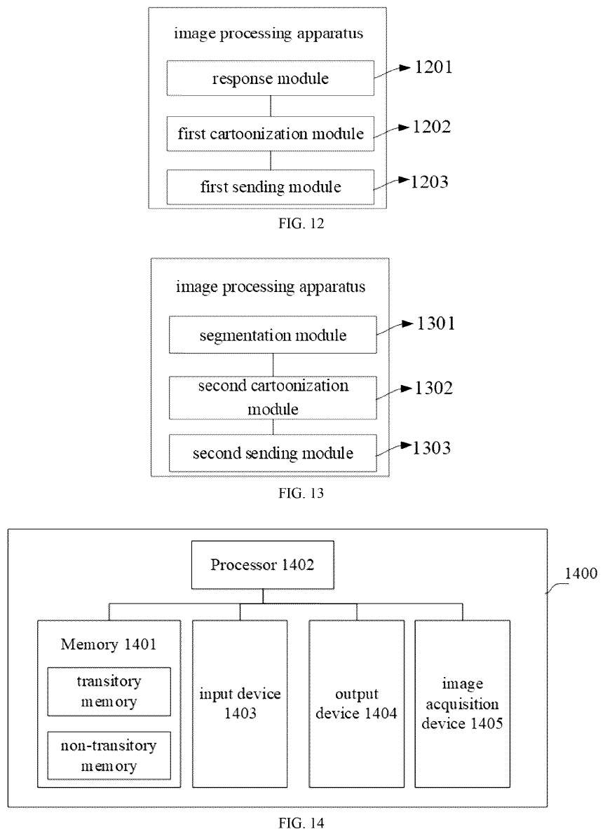

Based on the same inventive concept, the present disclosure also provides an image processing apparatus. Referring to FIG. 12, a schematic structural diagram of the image processing apparatus of the present disclosure is shown. As shown in FIG. 12, the device is applied to a terminal and can specifically include the following modules:

a response module 1201 configured for, in response to a triggered cartoonization request for a target image, instructing a cloud server to perform portrait segmentation on the target image, to obtain a portrait image and a background image;

a first cartoonization module 1202 configured for, based on a current performance parameter of the terminal, instructing a subject corresponding to the current performance parameter to perform cartoonization processing on the portrait image, and to fuse the background image and a cartoon portrait image obtained after the cartoonization processing; wherein the subject includes the terminal and/or the cloud server; and

a first sending module 1203, configured for outputting a cartoon image obtained by fusing to a display device, wherein the display device is used for displaying the cartoon image.

Optionally, the first sending module 1203 includes:
a state detection unit, configured for detecting a current communication state with the display device; and
a sending unit, configured for instructing the terminal or cloud server to send the cartoon image to the display device based on the current communication state.

Optionally, the sending unit is specifically configured for performing the following steps:
determining whether the display device is in a preset distance range based on the current communication state;
if the display device is in the preset distance range, sending the cartoon image to the display device based on communication connection with the display device; and
if the display device is not in the preset distance range, instructing the cloud server to send the cartoon image to the display device through a target gateway at a location of the display device.

Optionally, the communication connection includes at least one of Bluetooth, wireless, and near-field communication, and the gateway includes a Bluetooth gateway and/or a wireless communication gateway.

Optionally, the first cartoonization module 1202 is specifically configured for:
when the current performance parameter indicates that the terminal is at first-level performance, instructing the subject to be the terminal;
when the current performance parameter indicates that the terminal is at third-level performance, instructing the subject to be the cloud server; and
when the current performance parameter indicates that the terminal is at second-level performance, instructing that the subject includes the terminal and the cloud server; wherein the cloud server is configured to perform the cartoonization processing on the portrait image, and the terminal is configured to fuse the background image and the cartoon portrait image obtained after the cartoonization processing.

Optionally, fuse the background image and a cartoon portrait image obtained after the cartoonization processing includes:
transferring a target style in the background image based on style information of the target style in the cartoon portrait image, to obtain a cartoonization background image; wherein the target style at least includes a color style; and
fusing the cartoonization background image and the cartoon portrait image to obtain the cartoon image.

Optionally, transferring a target style in the background image based on style information of the target style in the cartoon portrait image includes:
converting the cartoon portrait image to lab color space to obtain a first image, and converting the background image to the lab color space to obtain a second image;
correcting a value of each pixel in a corresponding channel of the second image based on mean and standard deviation of each pixel in each channel of the first image; and
converting the corrected second image to RGB color space to obtain the cartoonization background image.

Optionally, the apparatus further includes:
an edge and brightness adjustment module, configured for sharpening object edges in the background image to obtain an edge image, and adjusting color brightness of the background image to obtain a color-adjusted image; and
a background cartoonization processing module, configured for performing edge enhancement on edges of the color-adjusted image based on the edge image to obtain an initial cartoonized background image;
correspondingly, when fusing the cartoon portrait image and the background image to obtain the cartoon image, fusing the cartoon portrait image and the initial cartoonized background image to obtain the cartoon image.

Optionally, perform cartoonization processing on the portrait image to obtain the cartoon portrait image includes:
inputting the portrait image into a generative adversarial network model, to perform the cartoonization processing on the portrait image; and
acquiring the cartoon portrait image output by the generative adversarial network model.

Optionally, the response module 1201 is specifically configured for, in response to the cartoonization request, sending the target image to the cloud server, to instruct the cloud server to perform the portrait segmentation on the target image; or
in response to the cartoonization request, sending an attribute identifier of the target image to the cloud server, to instruct the cloud server to perform the portrait segmentation on the target image with the attribute identifier in an image library.

Optionally, fuse the background image and a cartoon portrait image obtained after the cartoonization processing includes:
acquiring a mask image for the target image output by the cloud server, wherein the mask image is used to identify a foreground area and a background area in the target image;
performing noise suppression on the mask image; and
fusing the background image and the cartoon portrait image based on the mask image after the noise suppression.

Based on the same inventive concept, the present disclosure also provides an image processing apparatus. Referring to FIG. 13, a schematic structural diagram of the image processing apparatus of this disclosure is shown. As shown in FIG. 13, the apparatus is applied to the cloud server and can specifically include the following modules:
a segmentation module 1301 configured for, in response to an instruction sent by a terminal based on a cartoonization request of a target image, performing portrait segmentation on the target image, to obtain a portrait image and a background image;
a second cartoonization module 1302 configured for, when it is determined that a cloud server is a subject determined based on a current performance parameter of the terminal, performing cartoonization processing on the portrait image, and/or fusing the background image and a cartoon portrait image obtained after the cartoonization processing; and
a second sending module 1303, configured for sending a cartoon image obtained by fusing to the terminal and/or a display device.

Optionally, the cloud server connects a plurality of gateways, and the second sending module 1303 includes:
a connection information receiving unit, configured for receiving connection information uploaded by the plurality of gateways, wherein the connection information includes a device identifier of the display device connected to the gateways;
a target gateway determination unit, configured for determining a target gateway connected to the display device based on the connection information; and
a sending unit, configured for sending the cartoon image to the target gateway, to instruct the target gateway to send the cartoon image to the display device.

Optionally, the target gateway determination unit is specifically configured for performing following steps:
when one gateway is connected to the display device, regarding the gateway as the target gateway; and
when the plurality of gateways are connected to the display device, acquiring signal strength between the display device and each of the plurality of gateways, and determining the target gateway based on the signal strength.

Referring to FIG. 14, a structural block diagram of an electronic device 1400 according to an embodiment of the present disclosure is shown. As shown in FIG. 14, the embodiment of the present disclosure provides an electronic device, the electronic device 1400 may be used to execute the image processing method, and include a memory 1401, a processor 1402, and a computer program stored in the memory and executable on the processor. The processor 1402 is configured to execute the image processing method.

As shown in FIG. 14, in one embodiment, the electronic device 1400 can fully include an input device 1403, an output device 1404, and an image acquisition device 1405. When executing the image processing method of the embodiment of the present disclosure, the image acquisition device 1405 can acquire a target image, and then the input device 1403 can obtain the target image acquired by the image acquisition device 1405. The target image can be processed by the processor 1402 to perform image processing based on the target image, and the output device 1404 can output a cartoon image obtained after processing the target image.

Certainly, in one embodiment, the memory 1401 may include transitory memory and non-transitory memory, where the transitory memory can be understood as random access memory used to store and preserve data. The non-transitory memory refers to computer memory that stores data that does not disappear when the current is turned off. Certainly, the computer program of the image processing method in the present disclosure can be stored in both transitory and non-transitory memory, or in either of them.

The embodiment of the present disclosure also provides a computer-readable storage medium, which stores a computer program that enables a processor to execute the image processing method as described in the embodiment of the present disclosure.

Finally, it should be noted that in this specification, relational terms such as first and second are only used to distinguish one entity or operation from another, and do not necessarily require or imply any actual relationship or order between these entities or operations. Moreover, the terms “including/comprising”, “containing”, or any other variation thereof are intended to encompass non-exclusive inclusion, such that a process, method, good, or equipment that includes a series of elements includes not only those elements, but also other elements not explicitly listed, or elements inherent to such process, method, good, or equipment. Without further limitations, the element defined by the statement “including one . . . ” does not exclude the existence of other identical elements in the process, method, product, or device that includes the element in question.

The above provides a detailed introduction to an image processing method, an image processing system and apparatus, a device, and a medium provided in the present disclosure. Specific examples are applied in this specification to explain the principles and implementation methods of the present disclosure. The above embodiments are only used to assist in understanding the method and its core ideas of the present disclosure. Meanwhile, for persons skilled in the art, there may be changes in the specific implementations and application scope based on the ideas of the present disclosure. In summary, the content of this specification should not be understood as limiting the present disclosure.

After considering the specification and practicing the invention disclosed herein, persons skilled in the art will easily come up with other implementation solutions of the present disclosure. The present disclosure is intended to cover any variations, uses, or adaptive changes of the present disclosure that follow the general principles of the present disclosure and include common knowledge or customary technical means in the art that are not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes can be made without departing from its scope. The scope of the present disclosure is limited only by the appended claims.

The term “one embodiment”, “embodiment” or “one or more embodiments” referred to in this specification means that specific features, structures or characteristics described in conjunction with the embodiments are included in at least one embodiment of the present disclosure. Furthermore, please note that the word “in one embodiment” may not necessarily refer to the same embodiment.

In the specification provided here, a large number of specific details are explained. However, it can be understood that the embodiments of the present disclosure can be practiced without these specific details. In some examples, well-known methods, structures, and techniques are not shown in detail to avoid blurring the understanding of this specification.

In the claims, any reference symbols located between parentheses should not be constructed as limitations on the claims. The word “comprising” does not exclude the existence of elements or steps that are not listed in the claims. The word “a/an” or “one” before the component does not exclude the existence of multiple such components. This disclosure can be implemented by means of hardware including several different components and by means of appropriately programmed computers. In the unit claims listing several devices, several of these devices may be specifically embodied through the same hardware item. The use of words such as first, second, and third does not indicate any order. These words can be interpreted as names.

Finally, it should be noted that the above embodiments are only used to illustrate the technical solution of the present disclosure and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions of the present disclosure.

1. An image processing method, applied to a terminal, wherein the method comprises:
in response to a triggered cartoonization request for a target image, instructing a cloud server to perform portrait segmentation on the target image, to obtain a portrait image and a background image;
based on a current performance parameter of the terminal, instructing a subject corresponding to the current performance parameter to perform cartoonization processing on the portrait image, and to fuse the background image and a cartoon portrait image obtained after the cartoonization processing; wherein the subject comprises the terminal and/or the cloud server; and
outputting a cartoon image obtained by fusing to a display device, wherein the display device is used for displaying the cartoon image.

2. The method according to claim 1, wherein outputting a cartoon image obtained by fusing to a display device comprises:
determining whether the display device is in a preset distance range based on a current communication state with the display device;
if the display device is in the preset distance range, sending the cartoon image to the display device based on communication connection with the display device; and
if the display device is not in the preset distance range, instructing the cloud server to send the cartoon image to the display device through a target gateway at a location of the display device.

3. The method according to claim 1, wherein based on a current performance parameter of the terminal, instructing a subject corresponding the current performance parameter to perform cartoonization processing on the portrait image, and to fuse the background image and a cartoon portrait image obtained after the cartoonization processing comprises:
when the current performance parameter indicates that the terminal is at first-level performance, instructing the subject to be the terminal;
when the current performance parameter indicates that the terminal is at third-level performance, instructing the subject to be the cloud server; and
when the current performance parameter indicates that the terminal is at second-level performance, instructing that the subject comprises the terminal and the cloud server; wherein the cloud server is configured to perform the cartoonization processing on the portrait image, and the terminal is configured to fuse the background image and the cartoon portrait image obtained after the cartoonization processing.

4. The method according to claim 1, wherein fuse the background image and a cartoon portrait image obtained after the cartoonization processing comprises:
transferring a target style in the background image based on style information of the target style in the cartoon portrait image, to obtain a cartoonization background image; wherein the target style at least comprises a color style; and
fusing the cartoonization background image and the cartoon portrait image to obtain the cartoon image.

5. The method according to claim 4, wherein transferring a target style in the background image based on style information of the target style in the cartoon portrait image comprises:
converting the cartoon portrait image to lab color space to obtain a first image, and converting the background image to the lab color space to obtain a second image;
correcting a value of each pixel in a corresponding channel of the second image based on mean and standard deviation of each pixel in each channel of the first image; and
converting the corrected second image to RGB color space to obtain the cartoonization background image.

6. The method according to claim 1, wherein before fusing the background image and the cartoon portrait image, the method further comprises:
sharpening object edges in the background image to obtain an edge image, and adjusting color brightness of the background image to obtain a color-adjusted image; and
performing edge enhancement on edges of the color-adjusted image based on the edge image to obtain an initial cartoonized background image;
wherein fusing the cartoon portrait image and the background image to obtain the cartoon image comprises:
fusing the cartoon portrait image and the initial cartoonized background image to obtain the cartoon image.

7. The method according to claim 1, wherein perform cartoonization processing on the portrait image comprises:
inputting the portrait image into a generative adversarial network model, to perform the cartoonization processing on the portrait image; and
acquiring the cartoon portrait image output by the generative adversarial network model.

8. The method according to claim 1, wherein in response to a triggered cartoonization request for a target image, instructing a cloud server to perform portrait segmentation on the target image, to obtain a portrait image and a background image comprises:
in response to the cartoonization request, sending the target image to the cloud server, to instruct the cloud server to perform the portrait segmentation on the target image; or
in response to the cartoonization request, sending an attribute identifier of the target image to the cloud server, to instruct the cloud server to perform the portrait segmentation on the target image with the attribute identifier in an image library.

9. The method according to claim 1, wherein fuse the background image and a cartoon portrait image obtained after the cartoonization processing comprises:
acquiring a mask image for the target image output by the cloud server, wherein the mask image is used to identify a foreground area and a background area in the target image;
performing noise suppression on the mask image; and
fusing the background image and the cartoon portrait image based on the mask image after the noise suppression.

10. An image processing method, applied to a server, wherein the method comprises:
in response to an instruction sent by a terminal based on a cartoonization request of a target image, performing portrait segmentation on the target image, to obtain a portrait image and a background image;
when it is determined that a cloud server is a subject determined based on a current performance parameter of the terminal, performing cartoonization processing on the portrait image, and/or fusing the background image and a cartoon portrait image obtained after the cartoonization processing; and
sending a cartoon image obtained by fusing to the terminal and/or a display device.

11. The method according to claim 10, wherein the cloud server connects a plurality of gateways, and sending a cartoon image obtained by fusing to a display device comprises:
receiving connection information uploaded by the plurality of gateways, wherein the connection information comprises a device identifier of the display device connected to the gateways;
determining a target gateway connected to the display device based on the connection information; and
sending the cartoon image to the target gateway, to instruct the target gateway to send the cartoon image to the display device.

12. The method according to claim 11, wherein determining a target gateway connected to the display device based on the connection information comprises:
when one gateway is connected to the display device, regarding the gateway as the target gateway; and
when the plurality of gateways are connected to the display device, acquiring signal strength between the display device and each of the plurality of gateways, and determining the target gateway based on the signal strength.

13. An image processing system, comprising the cloud server, a plurality of terminals and a plurality of display devices; wherein the plurality of terminals are configured to perform the method according to claim 1, the plurality of display devices are configured to display the cartoon image, and the cloud server is configured to perform operations comprising:
in response to an instruction sent by a terminal based on a cartoonization request of a target image, performing portrait segmentation on the target image, to obtain a portrait image and a background image;
when it is determined that a cloud server is a subject determined based on a current performance parameter of the terminal, performing cartoonization processing on the portrait image, and/or fusing the background image and a cartoon portrait image obtained after the cartoonization processing; and
sending a cartoon image obtained by fusing to the terminal and/or a display device.

14. The system according to claim 13, wherein the plurality of display devices comprise at least one of an electrophoretic display type badge, a conference doorplate, and a conference table card.

15. (canceled)

16. (canceled)

17. An electronic device, comprising a memory, a processor, and a computer program stored on the memory and executable on the processor, wherein the computer program, when executed by the processor, implements the method according to claim 1.

18. A non-transitory computer-readable storage medium, wherein a computer program stored thereon causes a processor to perform the method according to claim 1.

19. The method according to claim 2, wherein the communication connection includes at least one of Bluetooth, wireless, and near-field communication, and a gateway includes a Bluetooth gateway and/or a wireless communication gateway.

20. The system according to claim 13, wherein the plurality of terminals are connected to the cloud server through a HTTP protocol; and the plurality of terminals and the plurality of display devices are connected through Bluetooth or near field communication.

21. An electronic device, comprising a memory, a processor, and a computer program stored on the memory and executable on the processor, wherein the computer program, when executed by the processor, implements the method according to claim 10.

22. A non-transitory computer-readable storage medium, wherein a computer program stored thereon causes a processor to perform the method according to claim 10.
